(19) United States
(12) Patent Application Publication
(10) Pub. No.: US 2004/0247508 A1
(43) Pub. Date: Dec. 9, 2004

(54) Decomposing dialkyl phthalates using coal fly ash

(76) Inventors: Kiyoharu Sakurai, Nagano (JP); Minoru Okuda, Nagano (JP)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/458,787

(22) Filed: Jun. 9, 2003

(51) Int. Cl. B01D 53/70

(52) U.S. Cl. 423/240 R

(57) ABSTRACT

Decomposition of dialkyl phthalates exposed to coal fly ash is disclosed. Alkaline constituents eluted from the fly ash in the liquid phase hydrolyze the dialkyl phthalate. The fly ash acts as not only an adsorber but also as a decomposer.

### FIELD OF THE INVENTION

The present invention relates to a method of decomposing dialkyl phthalate esters using coal fly ash. Dialkyl phthalate esters will be referred to herein as “dialkyl phthalates.”

### BACKGROUND OF THE INVENTION

Coal fly ash produced by coal combustion at electric power plants consists of non-crystalline and porous particles mainly made up of aluminosilicate. A significant amount of fly ash is emitted to the natural environment as an industrial waste material. The fly ash is available for use as a fine adsorber and as a raw material for making artificial zeolites (Henmi et al. U.S. Pat. No. 6,299,854). Utilization of such a waste material is worthwhile for conservation and improvement of the environment.

Endocrine disruptors such as dialkyl phthalates, bisphenol, and alkyl phenol compounds pollute soil and groundwater and affect heredity and reproduction in ecological systems. This is a problem of increasing seriousness. Dialkyl phthalates are used as plasticizers in polyvinyl chloride (PVC), polyvinylidene chloride, and/or other synthetic resins. When such resins are exposed to water, they emit the dialkyl phthalates, which are weakly adsorbed on the polymer networks and which are easily dissolved in water.

The toxicity of dialkyl phthalates is of vital interest because of their use in many consumer products leading to widespread human exposures and environmental contamination. Of particular concern is their use as plasticizers in medical products and children's toys made of polyvinyl chloride (PVC). Children chewing on PVC toys are exposed to phthalate plasticizers, and patients receiving intravenous, respiratory, or intestinal therapies from PVC products are exposed to varying amounts of the commonly used plasticizer, diethylhexyl phthalate (DEHP).

It is very important for dialkyl phthalates to decompose in order to avoid harming life on earth. Studies on photoinduced and photocatalyzed degradation of dialkyl phthalates have been performed. See A. Balabanovich et al., J. Vinyl Additive Technol. 3, 42 (1997); H. Yoshida et al., Chem. Lett. 715 (1999); K. Hasegawa et al., Chem. Lett. 890 (2001); M. Muneer et al., J. Photochem. Photobiol. A 143, 213 (2001); and O. Bajt, et al., Appl. Catal. B 33, 239 (2001). It is a worthwhile goal to achieve the decomposition of dialkyl phthalates and even more so if this goal can be achieved without light or added heat energy.

### SUMMARY OF THE INVENTION

The present invention achieves the worthwhile goal of decomposing dialkyl phthalates by a surprising process using coal fly ash to cause the decomposition of dialkyl phthalates in water at ambient room temperature. The process can even be implemented without light or added heat energy.

The invention is a process for decomposing dialkyl phthalates using coal fly ash, including the steps of: (a) providing an aqueous solution containing a dialkyl phthalate; and (b) exposing the aqueous solution containing a dialkyl phthalate for a sufficient time to coal fly ash, whereby the dialkyl phthalate is decomposed.

The dialkyl phthalate may be di-(2-ethylhexyl) phthalate; di-(heptyl, nonyl, undecyl) phthalate; di-n-octyl phthalate; dibutyl phthalate (DBP); dicapryl phthalate (DCP); dicyclohexyl phthalate (DCHP); didecyl phthalate (DDP); diethyl phthalate (DEP); diethylhexyl phthalate (DEHP); diheptyl phthalate (DHP); dihexyl phthalate (DHXP); diisobutyl phthalate (DIBP); diisodecyl phthalate (DIDP); diisoheptyl phthalate (DIHP); diisohexyl phthalate (DIHXP); diisononyl phthalate (DINP); diisooctyl phthalate (DIOP); diisopentyl phthalate (DIPP); diisotridecyl phthalate (DITDP); dimethyl cyclohexyl phthalate; dimethyl phthalate (DMP); dinonyl phthalate (DNP); dioctyl phthalate (DOP); dipentyl phthalate; ditridecyl phthalate (DTDP); diundecyl phthalate (DUP); heptylundecyl phthalate (HUP); hexyl octyl decyl phthalate (HXODP); nonyl undecyl phthalate (NUP); and/or octyl decyl phthalate (ODP).

The dialkyl phthalate in the aqueous solution may come from an article made of polyvinyl chloride, polyvinylidene chloride, and/or other synthetic resins, wherein the dialkyl phthalate was used as a plasticizer.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1a shows the UV-VIS absorption spectra of a 1.0×10⁻⁴ mol/l diethyl phthalate solution (Sample #1) exposed to the fly ash observed as a function of exposure (reaction) time. FIG. 1a shows the changes in the spectra in absorbance at 218 nm, 235 nm, and 276 nm of the 1.0×10⁻⁴ mol/l diethyl phthalate solution. The spectra were observed at eight reaction times of (1) 0 hours, (2) 10 hours, (3) 20 hours, (4) 30 hours, (5) 40 hours, (6) 50 hours, (7) 60 hours, and (8) 170 hours. The horizontal axis is wavelength in nanometers (nm) and the vertical axis is absorbance.

FIG. 1b shows the UV-VIS absorbance of a 1.0×10⁻⁴ mol/l diethyl phthalate solution (Sample #1) at 218 nm, 235 nm, and 276 nm exposed to the fly ash observed as a function of exposure (reaction) time. As shown in FIG. 1b, the absorbance was observed at eleven reaction times of 0 hours, 5 hours, 10 hours, 15 hours, 20 hours, 30 hours, 40 hours, 50 hours, 60 hours, 70 hours, and 170 hours. The horizontal axis is time in hours and the vertical axis is absorbance.

FIG. 2 shows the UV-VIS absorption spectra of (1) diethyl phthalate and (2) ethyl benzoate in an aqueous solution, and (3) phthalic acid and (4) benzoic acid in an aqueous NaOH solution. The horizontal axis is wavelength in nanometers (nm) and the vertical axis is ε in units of 10³ dm³ mol⁻¹ cm⁻¹

FIG. 3a shows the gas chromatography-mass spectrometry (GC-MS) chromatograms of an aqueous solution of diethyl phthalate at a concentration of 1.0×10⁻⁴ mol/l (Sample #2) exposed to fly ash for three time periods as labeled in FIG. 3(a) for (1) 0 hours, (2) 24 hours, and (3) 170 hours. The horizontal axis is retention time in minutes and the vertical axis is the total ion current. BA represents benzoic acid. DEP represents diethyl phthalate.

FIG. 3b shows gas chromatography-mass spectrometry (GC-MS) chromatograms of an aqueous solution of diethyl phthalate at a concentration of 1.0×10⁻³ mol/l (Sample #3) exposed to fly ash for three time periods as labeled in FIG. 3(b) for (1) 0 hours, (2) 24 hours, and (3) 170 hours. The horizontal axis is retention time in minutes and the vertical axis is the total ion current. EB represents ethyl benzoate. BA represents benzoic acid. DEP represents diethyl phthalate.

FIG. 4 shows the reaction pathways for the decomposition of diethyl phthalate caused by exposure to the fly ash.

### DETAILED DESCRIPTION OF THE EMBODIMENTS

Dialkyl phthalates used as plasticizers include the following compounds: di-(2-ethylhexyl) phthalate; di-(heptyl, nonyl, undecyl) phthalate; di-n-octyl phthalate; dibutyl phthalate (DBP); dicapryl phthalate (DCP); dicyclohexyl phthalate (DCHP); didecyl phthalate (DDP); diethyl phthalate (DEP); diethylhexyl phthalate (DEHP); diheptyl phthalate (DHP); dihexyl phthalate (DHXP); diisobutyl phthalate (DIBP); diisodecyl phthalate (DIDP); diisoheptyl phthalate (DIHP); diisohexyl phthalate (DIHXP); diisononyl phthalate (DINP); diisooctyl phthalate (DIOP); diisopentyl phthalate (DIPP); diisotridecyl phthalate (DITDP); dimethyl cyclohexyl phthalate; dimethyl phthalate (DMP); dinonyl phthalate (DNP); dioctyl phthalate (DOP); dipentyl phthalate; ditridecyl phthalate (DTDP); diundecyl phthalate (DUP); heptylundecyl phthalate (HUP); hexyl octyl decyl phthalate (HXODP); nonyl undecyl phthalate (NUP); and octyl decyl phthalate (ODP).

The coal fly ash used in this research was from an electric power plant. Diethyl phthalate (reagent grade) was purchased from a chemical supplier and was used without further purification. Phthalic acid (S grade), ethyl benzoate (S grade), benzoic acid (reagent grade) and sodium hydroxide (S grade) were purchased from a chemical supplier and were also used without further purification. Deionized distilled water was used as a solvent. Two aqueous solutions of diethyl phthalate were prepared in concentrations of 1.0×10⁻⁴ mol/l and 1.0×10⁻³ mol/l, respectively. Basic solutions of diethyl phthalate, phthalic acid, ethyl benzoate, and benzoic acid (all at a concentration of 1.0×10⁻⁴ mol/l) were prepared using a NaOH aqueous solution with a NaOH concentration of 0.10 mol/l.

Sample #1 was prepared by placing 3.0 ml of the aqueous solution of diethyl phthalate having a concentration of 1.0×10⁻⁴ mol/l and 0.10 g of fly ash into an optical quartz cell (path length 10.0 mm). The diethyl phthalate solution and the coal fly ash were divided by a glass filter (Advantec GS-25) in order to avoid the suspension of the fly ash. It was ascertained that the diethyl phthalate solution permeated through the glass filter and that the adsorption of diethyl phthalate onto the glass filter was negligible. This 3.0 ml sample was allowed to stand at room temperature in the dark. UV-VIS absorption spectra of the solution were measured using a Hitachi U-3210 spectrophotometer.

Sample #2 and Sample #3 were prepared by making suspensions consisting of 30.0 ml of the diethyl phthalate aqueous solution in concentrations of 1.0×10⁻⁴ mol/l and 1.0×10⁻³ mol/l and 1.0 g of the fly ash. Thus, Sample #2 consisted of 30.0 ml of diethyl phthalate having a concentration of 1.0×10⁻⁴ mol/l and 1.0 g of the fly ash. Sample #3 consisted of 30.0 ml of diethyl phthalate having a concentration of 1.0×10⁻³ mol/l and 1.0 g of the fly ash. The samples were prepared in air-tight vessels and allowed to stand at room temperature in the dark. These suspensions were then filtered to separate the solution from the fly ash by using a membrane filter (Advantec C020A) after various exposure (reaction) times. Gas chromatography-mass spectrometry (GC-MS) of the solutions was performed using a Shimadzu GCMS-QP5000. The resulting two aqueous sample solutions were injected into the gas chromatograph without extraction.

Blank tests showed that little organic substance was eluted from the coal fly ash by water alone.

Optimal molecular geometries and transition energies for diethyl phthalate, phthalic acid, ethyl benzoate, benzoic acid, and anions of phthalic acid and benzoic acid in water were calculated using the PM3 (Parametric Method 3) and INDO/S (Intermediate Neglect of Differential Overlap/Spectroscopic parametrization) methods for the purpose of spectral assignment.

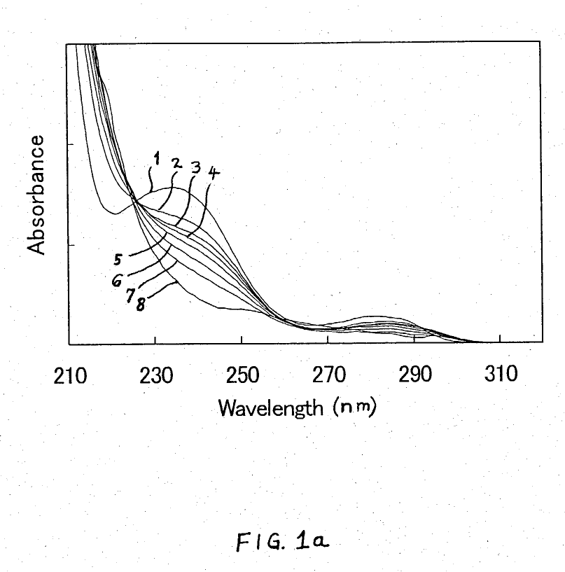

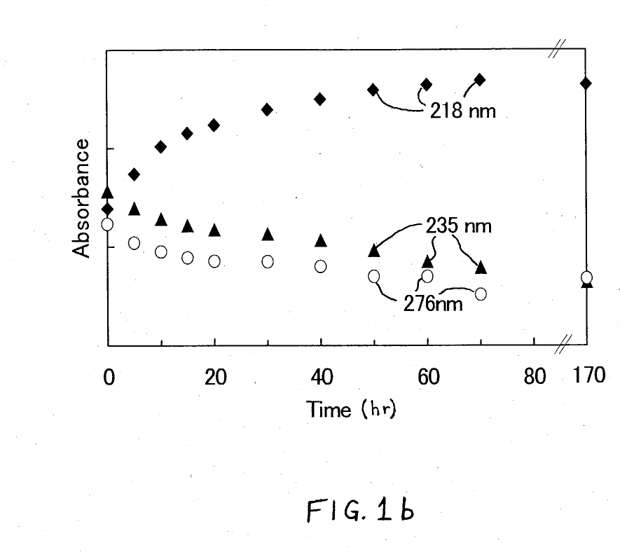

The UV-VIS absorption spectra of Sample #1 (consisting of an aqueous solution of 1.0×10⁻⁴ mol/l diethyl phthalate exposed to the fly ash) were observed as a function of reaction time. FIG. 1a shows the changes in the spectra of Sample #1 and FIG. 1b the changes in absorbance of Sample #1 at 218 nm, 235 nm, and 276 nm. In FIG. 1a, the spectrum observed just after preparation (at time (1) of 0 hours) of Sample #1 shows the typical absorption spectrum of diethyl phthalate and exhibits two maxima at 235 nm and 276 nm. As shown in FIG. 1b, the intensity of absorbance at 235 nm and 276 nm gradually decreased with time while the absorbance at 218 nm increased gradually with time. The band found at 276 nm shifted to the shorter wavelength side with time and became broader than the band for diethyl phthalate. The degree of change of the spectrum became smaller after time (7) 60 hours of reaction time with the fly ash.

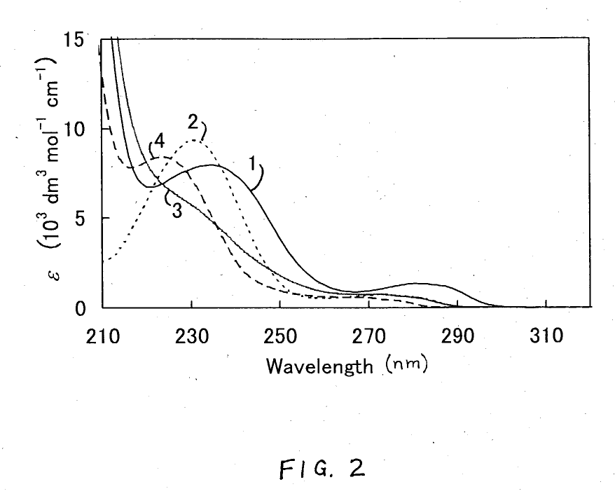

FIG. 2 shows a comparison of the absorption spectra of diethyl phthalate (spectrum 1) and ethyl benzoate (spectrum 2) in water, and of phthalic acid (spectrum 3) and benzoic acid (spectrum 4) in aqueous NaOH solutions. According to the results of the INDO/S calculations, the absorption bands at 235 and 276 nm of diethyl phthalate (spectrum 1) are due to some transitions having different characters.

The main contributions are HOMO (Highest Occupied Molecular Orbital) to LUMO (Lowest Unoccupied Molecular Orbital) (75%) and next HOMO to next LUMO (16%) configurations for the 235 nm band and HOMO to next LUMO (38%) and next HOMO to LUMO (48%) configurations for the 276 nm band, respectively. The transitions neglected included the n−π* character for the 276 nm band because its contribution was small and the n−π* level tends to be estimated lower in the case of aromatic carboxyl compounds. The assignments for diethyl phthalate essentially coincide with those for ethyl benzoate, phthalic acid and benzoic acid. Phthalic acid and benzoic acid exist as their carboxylate anions in the basic solutions. On the other hand, diethyl phthalate and ethyl benzoate were gradually hydrolyzed to form the carboxylate anions of phthalic acid and benzoic acid in such basic solutions, respectively. The transition characters for the anions of phthalic acid and benzoic acid are different from the neutral phthalic acid and benzoic acid, and the esters, diethyl phthalate and ethyl benzoate. The broad bands at around 230 nm and 270 nm for the phthalic acid dianion, which are blue-shifted from those of diethyl phthalate, consist of HOMO to next LUMO (57%) and next HOMO to LUMO (35%) configurations for the 230 nm band and HOMO to LUMO (58%) and next HOMO to next LUMO (35%) configurations for the 270 nm band, respectively. The assignments for the phthalic acid dianion essentially coincide with those for the benzoic acid anion.

The major spectral change shown in FIG. 1a explains the transformation from diethyl phthalate to the anion of phthalic acid, supposedly, via the ethyl phthalate anion. In practice, the pH range of the solution was 10-11. This value indicates that such weak acid exists as an anion in the aqueous solution including the fly ash, which supports these results. The spectrum observed after 170 hours, however, has a shoulder around 220 nm and somewhat different shape from the anion of phthalic acid. Inclusion of the benzoic acid anion and some other constituents due to the decomposition of phthalic acid anion makes the difference. These results indicate that the adsorption of phthalic acid on the surface of the fly ash particles occurred first and then some chemical reactions took place.

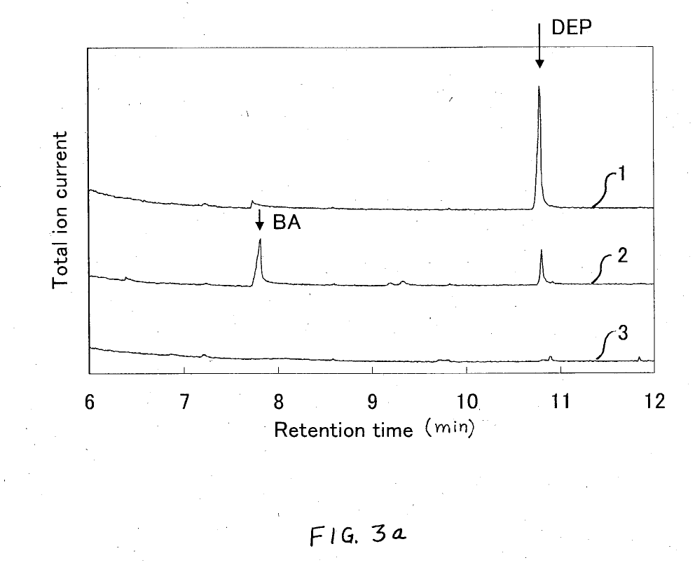

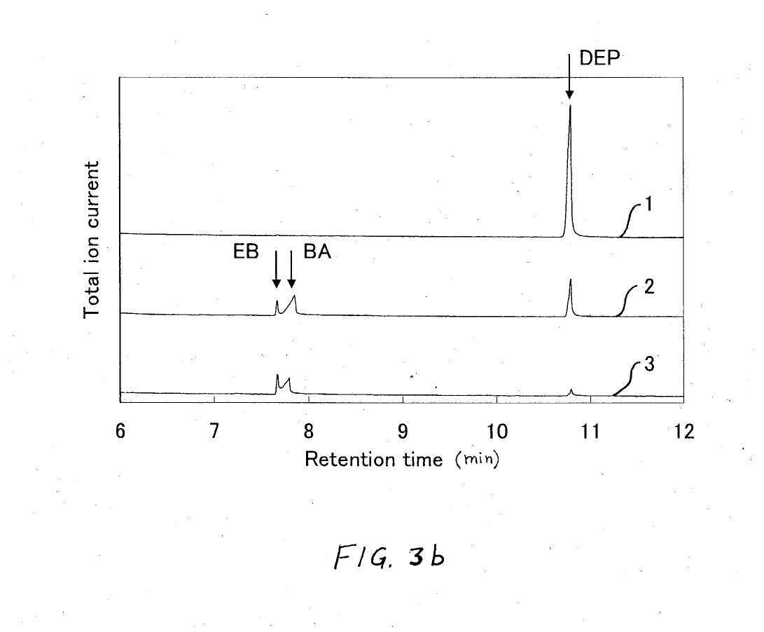

FIG. 3a shows the gas chromatography-mass spectrometry (GC-MS) chromatograms of diethyl phthalate solutions having a concentration of 1.0×10⁻⁴ mol/l (Sample #2) after being exposed to the fly ash for (1) 0 hours, (2) 24 hours, and (3) 170 hours. In FIG. 3a, the peaks located at 7.8 and 10.8 minutes can be assigned to benzoic acid (BA) and diethyl phthalate (DEP), respectively. The peak intensity at 10.8 minutes became smaller with the progress of the reaction compared to that observed just after the sample preparation. The peak attributed to benzoic acid (BA) was observed in the sample runs after 24 hours of exposure to the fly ash and almost disappeared after 170 hours of exposure to the fly ash. These changes in the graph indicate that benzoic acid (BA) was produced in the decomposition of diethyl phthalate (DEP) and then decomposed. The decomposition of diethyl phthalate (DEP) and the production of benzoic acid (BA) correspond to the results of spectral measurements. Phthalic acid, which is the intermediate product of the reaction from diethyl phthalate (DEP) to benzoic acid (BA), was hardly detected in the runs. The disappearance of benzoic acid (BA) indicates a possibility of the production of volatile compounds, which are difficult to detect.

FIG. 3b shows the gas chromatography-mass spectrometry (GC-MS) chromatograms of the diethyl phthalate solution having a concentration of 1.0×10⁻³ mol/l (Sample #3) after being exposed to the fly ash for (1) 0 hours, (2) 24 hours, and (3) 170 hours. In FIG. 3b, the peaks located at 7.6, 7.8 and 10.8 min can be assigned to ethyl benzoate (EB), benzoic acid (BA), and diethyl phthalate (DEP), respectively. The diethyl phthalate (DEP) peak became smaller with the progress of the reaction in the same way of FIG. 3a. The peaks attributed to ethyl benzoate (EB) and benzoic acid (BA) were observed in the sample runs after being exposed to the fly ash for 24 hours (time 2) and 170 hours (time 3). These results indicate the decomposition of diethyl phthalate (DEP) and the production of ethyl benzoate (EB) and benzoic acid (BA). Ethyl benzoate (EB) and benzoic acid (BA) were produced from ethyl phthalate anion and phthalic acid anion, respectively, which were the products from the hydrolysis of diethyl phthalate (DEP). In the case of this 1.0×10⁻³ mol/l diethyl phthalate (DEP) sample (Sample #3), it took longer time to hydrolyze from diethyl phthalate (DEP) to phthalic acid anion than in the case of the 1.0×10⁻⁴ mol/l diethyl phthalate (DEP) sample (Sample #2), so that there was a certain amount of ethyl phthalate anion to change into ethyl benzoate (EB). Ethyl phthalate and phthalic acid, however, were not detected by the GC-MS analysis.

It is probable that the anions of ethyl phthalate and phthalic acid in aqueous phase were efficiently adsorbed on the fly ash during the filtration before the GC-MS analysis because the membrane filter, having quite small pores (0.2 μm), was clogged by the fly ash particles. The neutral ethyl phthalate and phthalic acid were actually detected from solutions extracted with an organic solvent.

The coal fly ash consists of SiO₂ (50.5% by wt.), Al₂O₃ (22.7% by wt.), CaO (9.6% by wt.) and Na₂O (1.4% by wt.). The CaO and Na₂O react with H₂O and form Ca(OH)₂ and NaOH, which are dissolved in the aqueous solution. The diethyl phthalate solution including the fly ash indicated basic. Considering the solubility of Ca(OH)₂ in water, half of that included in the fly ash are not dissolved in the solution. The Ca(OH)₂ sites existing on the surface of the fly ash particle act as a strong base.

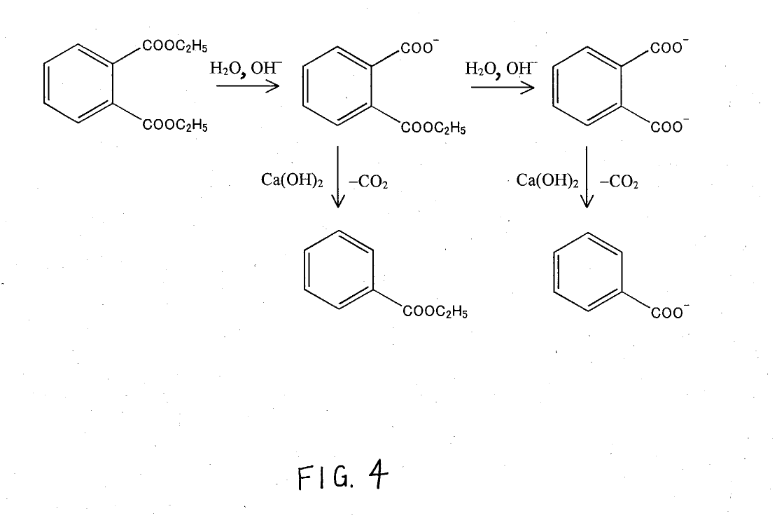

While not desiring to be bound by this theory, it is believed that the alkaline constituents hydrolyzed diethyl phthalate in the liquid phase suspending the fly ash to form ethyl phthalate and/or phthalic acid, which were adsorbed on the fly ash and then decarboxylated on the surface of the fly ash. The pathways of these reactions are shown in FIG. 4. The carboxylic groups of ethyl phthalate and phthalic acid interacted with the Ca(OH)₂ sites and were decarboxylated to form ethyl benzoate (EB) and benzoic acid (BA), respectively. Then these compounds were desorbed into the liquid phase.

In the case of the 1.0×10⁻⁴ mol/l sample (Sample #2) (FIG. 3a), ethyl benzoate (EB) was hardly detected because the hydrolysis capacity of the fly ash is high compared with the concentration of diethyl phthalate needed to change ethyl phthalate into phthalic acid. The peak intensities of ethyl benzoate (EB) and benzoic acid (BA) in the gas chromatograms are relatively weak compared to the extent of the decrease in that of diethyl phthalate (DEP), suggesting that other hardly-detected chemicals were also produced. On the other hand, the absorption spectra of the samples reacted for long time have a band in the wavelength range less than 220 nm, indicating the existence of benzene, benzene derivatives, and/or other volatile compounds of lower molecular weight. Though the results are not shown here, the benzenes were also detected in the gas phase of the gas-tight vessel containing the samples.

Alkaline constituents eluted from the coal fly ash in the liquid phase gradually hydrolyzed diethyl phthalate to produce ethyl phthalate anion and/or phthalic acid anion. The carboxylic groups of the ethyl phthalate and the phthalic acid, which were adsorbed on the fly ash, interacted with the basic Ca(OH)₂ sites and were decarboxylated to form ethyl benzoate (EB) and benzoic acid (BA), respectively. These products were gradually desorbed to the liquid phase. The formation of ethyl benzoate (EB) and benzoic acid (BA) was followed by the decomposition into benzenes and/or the other volatile compounds of lower molecular weight. Thus, coal fly ash is able to decompose dialkyl phthalates, which are endocrine disruptors.

The process can be performed wherein the concentration of the dialkyl phthalate is from 1.0×10⁻⁵ mol/l to 1.0×10⁻² mol/l and from 1.0×10⁻⁴ mol/l to 1.0×10⁻³ mol/l.

The dialkyl phthalate can be di-(2-ethylhexyl) phthalate; di-(heptyl, nonyl, undecyl) phthalate; di-n-octyl phthalate; dibutyl phthalate (DBP); dicapryl phthalate (DCP); dicyclohexyl phthalate (DCHP); didecyl phthalate (DDP); diethyl phthalate (DEP); diethylhexyl phthalate (DEHP); diheptyl phthalate (DHP); dihexyl phthalate (DHXP); diisobutyl phthalate (DIBP); diisodecyl phthalate (DIDP); diisoheptyl phthalate (DIHP); diisohexyl phthalate (DIHXP); diisononyl phthalate (DINP); diisooctyl phthalate (DIOP); diisopentyl phthalate (DIPP); diisotridecyl phthalate (DITDP); dimethyl cyclohexyl phthalate; dimethyl phthalate (DMP); dinonyl phthalate (DNP); dioctyl phthalate (DOP); dipentyl phthalate; ditridecyl phthalate (DTDP); diundecyl phthalate (DUP); heptylundecyl phthalate (HUP); hexyl octyl decyl phthalate (HXODP); nonyl undecyl phthalate (NUP); and/or octyl decyl phthalate (ODP).

The pH can be 9 to 12 and the pH can be 10 to 11.

The time of exposure to the coal fly ash can be from 1 to 200 hours and the time of exposure to the coal fly ash can be from 50 to 170 hours.

From 10 grams to 50 grams of coal fly ash can be used for each liter of aqueous solution containing the dialkyl phthalate. And 20 grams to 40 grams of coal fly ash can be used for each liter of aqueous solution containing the dialkyl phthalate.

One practical application for the present process is to decompose dialkyl phthalates which have been dissolved in water and removed from articles made of polyvinyl chloride (PVC), polyvinylidene chloride, and/or other synthetic resins, where dialkyl phthalates are used as plasticizers, such as in medical products and children's toys.

Unless indicated otherwise, in stating a numerical range for a compound or a time or other process matter or property, such a range is intended to specifically designate and disclose the minimum and the maximum for the range and each number, including each fraction and/or decimal, between the stated minimum and maximum for the range. For example, a range of 1 to 10 discloses 1.0, 1.1, 1.2 . . . 2.0, 2.1, 2.2, . . . and so on, up to 10.0. Similarly, a range of 500 to 1000 discloses 500, 501, 502, . . . and so on, up to 1000, including every number and fraction or decimal therewithin. “Up to x” means “x” and every number less than “x”, for example, “up to 5” discloses 0.1, 0.2, 0.3, . . . , and so on up to 5.0.

While several embodiments of the invention has been illustrated and described, it will be appreciated that various changes can be made therein without departing from the spirit and scope of the invention.

The embodiments of the invention in which an exclusive property or privilege is claimed are defined as follows:

1. A process for decomposing dialkyl phthalates using coal fly ash, comprising:
(a) providing an aqueous solution containing at least one dialkyl phthalate; and
(b) exposing said aqueous solution containing at least one dialkyl phthalate for a sufficient time to coal fly ash, whereby said dialkyl phthalate is decomposed.

2. The process defined in claim 1 wherein the concentration of said dialkyl phthalate is from 1.0×10⁻⁵ mol/l to 1.0×10⁻² mol/l.

3. The process defined in claim 2 wherein the concentration of said dialkyl phthalate is from 1.0×10⁻⁴ mol/l to 1.0×10⁻³ mol/l.

4. The process defined in claim 1 wherein said dialkyl phthalate is selected from the group consisting of di-(2-ethylhexyl) phthalate; di-(heptyl, nonyl, undecyl) phthalate; di-n-octyl phthalate; dibutyl phthalate (DBP); dicapryl phthalate (DCP); dicyclohexyl phthalate (DCHP); didecyl phthalate (DDP); diethyl phthalate (DEP); diethylhexyl phthalate (DEHP); diheptyl phthalate (DHP); dihexyl phthalate (DHXP); diisobutyl phthalate (DIBP); diisodecyl phthalate (DIDP); diisoheptyl phthalate (DIHP); diisohexyl phthalate (DIHXP); diisononyl phthalate (DINP); diisooctyl phthalate (DIOP); diisopentyl phthalate (DIPP); diisotridecyl phthalate (DITDP); dimethyl cyclohexyl phthalate; dimethyl phthalate (DMP); dinonyl phthalate (DNP); dioctyl phthalate (DOP); dipentyl phthalate; ditridecyl phthalate (DTDP); diundecyl phthalate (DUP); heptylundecyl phthalate (HUP); hexyl octyl decyl phthalate (HXODP); nonyl undecyl phthalate (NUP); and octyl decyl phthalate (ODP).

5. The process defined in claim 1 wherein the pH is 9 to 12.

6. The process defined in claim 5 wherein the pH is 10 to 11.

7. The process defined in claim 1 wherein the time of exposure to said coal fly ash is from 1 to 200 hours.

8. The process defined in claim 7 wherein the time of exposure to said coal fly ash is from 50 to 170 hours.

9. The process defined in claim 1 wherein 10 grams to 50 grams of coal fly ash is used for each liter of said aqueous solution containing at least one dialkyl phthalate.

10. The process defined in claim 9 wherein 20 grams to 40 grams of coal fly ash is used for each liter of said aqueous solution containing at least one dialkyl phthalate.

11. A process for decomposing dialkyl phthalates using coal fly ash, comprising:
(a) providing an aqueous solution containing at least one dialkyl phthalate, wherein said dialkyl phthalate is selected from the group consisting of di-(2-ethylhexyl) phthalate; di-(heptyl, nonyl, undecyl) phthalate; di-n-octyl phthalate; dibutyl phthalate (DBP); dicapryl phthalate (DCP); dicyclohexyl phthalate (DCHP); didecyl phthalate (DDP); diethyl phthalate (DEP); diethylhexyl phthalate (DEHP); diheptyl phthalate (DHP); dihexyl phthalate (DHXP); diisobutyl phthalate (DIBP); diisodecyl phthalate (DIDP); diisoheptyl phthalate (DIHP); diisohexyl phthalate (DIHXP); diisononyl phthalate (DINP); diisooctyl phthalate (DIOP); diisopentyl phthalate (DIPP); diisotridecyl phthalate (DITDP); dimethyl cyclohexyl phthalate; dimethyl phthalate (DMP); dinonyl phthalate (DNP); dioctyl phthalate (DOP); dipentyl phthalate; ditridecyl phthalate (DTDP); diundecyl phthalate (DUP); heptylundecyl phthalate (HUP); hexyl octyl decyl phthalate (HXODP); nonyl undecyl phthalate (NUP); and octyl decyl phthalate (ODP); and
(b) exposing said aqueous solution containing at least one dialkyl phthalate for a sufficient time to coal fly ash, whereby said dialkyl phthalate is decomposed.

12. The process defined in claim 11 wherein the concentration of said dialkyl phthalate is from 1.0×10⁻⁵ mol/l to 1.0×10⁻² mol/l.

13. The process defined in claim 11 wherein the concentration of said dialkyl phthalate is from 1.0×10⁻⁴ mol/l to 1.0×10⁻³ mol/l.

14. The process defined in claim 11 wherein the pH is 9 to 12.

15. The process defined in claim 14 wherein the pH is 10 to 11.

16. The process defined in claim 11 wherein the time of exposure to said coal fly ash is from 1 to 200 hours.

17. The process defined in claim 16 wherein the time of exposure to said coal fly ash is from 50 to 170 hours.

18. The process defined in claim 11 wherein 10 grams to 50 grams of coal fly ash is used for each liter of said aqueous solution containing at least one dialkyl phthalate.

19. The process defined in claim 18 wherein 20 grams to 40 grams of coal fly ash is used for each liter of said aqueous solution containing at least one dialkyl phthalate.

20. A process for decomposing diethyl phthalate using coal fly ash, comprising:
(a) providing an aqueous solution containing diethyl phthalate; and
(b) exposing said aqueous solution containing diethyl phthalate for a sufficient time to coal fly ash, whereby said diethyl phthalate is decomposed.

21. The process defined in claim 20 wherein the concentration of said diethyl phthalate is from 1.0×10⁻⁵ mol/l to 1.0×10⁻² mol/l.

22. The process defined in claim 20 wherein the concentration of said diethyl phthalate is from 1.0×10⁻⁴ mol/l to 1.0×10⁻³ mol/l.

23. The process defined in claim 20 wherein the pH is 9 to 12.

24. The process defined in claim 20 wherein the pH is 10 to 11.

25. The process defined in claim 20 wherein the time of exposure to said coal fly ash is from 1 to 200 hours.

26. The process defined in claim 20 wherein the time of exposure to said coal fly ash is from 50 to 170 hours.

27. The process defined in claim 20 wherein 10 grams to 50 grams of coal fly ash is used for each liter of said aqueous solution containing diethyl phthalate.

28. The process defined in claim 20 wherein 20 grams to 40 grams of coal fly ash is used for each liter of said aqueous solution containing diethyl phthalate.

29. The process defined in claim 1 wherein said dialkyl phthalate in said aqueous solution came from an article made of polyvinyl chloride, polyvinylidene chloride, and/or other synthetic resins, wherein said dialkyl phthalate was used as a plasticizer.

30. The process defined in claim 11 wherein said dialkyl phthalate in said aqueous solution came from an article made of polyvinyl chloride, polyvinylidene chloride, and/or other synthetic resins, wherein said dialkyl phthalate was used as a plasticizer.

31. The process defined in claim 20 wherein said diethyl phthalate in said aqueous solution came from an article made of polyvinyl chloride, polyvinylidene chloride, and/or other synthetic resins, wherein said diethyl phthalate was used as a plasticizer.
